(19) United States
(12) Patent Application Publication
(10) Pub. No.: US 2010/0303090 A1
(43) Pub. Date: Dec. 2, 2010

(54) DATA PROCESSING APPARATUS USING RING BUS, DATA PROCESSING METHOD ANDCOMPUTER-READABLE STORAGE MEDIUM

(75) Inventors: Hirowo Inoue, Kawasaki-shi (JP); Hisashi Ishikawa, Urayasu-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/787,248

(22) Filed: May 25, 2010

(30) Foreign Application Priority Data
May 29, 2009 (JP) 2009-130852

(51) Int. Cl. H04L 12/56

(52) U.S. Cl. 370/401

(57) ABSTRACT

In an apparatus connected to a ring bus, deadlocks and degradation in effective efficiency of the ring bus could occur when a plurality of data processing streams are input or a case when the amount of data inside a processing circuit increases/decreases is present. To solve this, degradation in processing efficiency is minimized by making a working speed of the ring bus faster than the working speed necessary for data processing to reduce occasions for suppression of data output by data moving around the ring bus.

### BACKGROUND OF THE INVENTION

1. Field of the Invention

The present invention relates to a data processing apparatus that performs data processing using a ring bus, a control method thereof, and a computer-readable storage medium.

2. Description of the Related Art

A method for connecting processing circuits by a ring-shaped bus is discussed in Japanese Patent No. 2522952 as a method for efficiently performing data processing by causing the processing circuits to perform parallel processing. Also, to perform parallel processing of filtering of images, a method for enabling a plurality of processors to receive overlapped data by adding a control code to data and capturing the data into the processors according to the control code is discussed in Japanese Patent Application Laid-Open No. 63-247858.

Also, to reduce competition of buses while allowing to easily change the order of processing of a plurality of processing circuits, a method for connecting a plurality of processing circuits and an (input/output) control circuit in a ring shape and causing packetized data to move around the processing circuits connected in a ring shape is discussed in Japanese Patent No. 3907471.

According to the method of Japanese Patent No. 2522952, data input through an interface from an external memory or the like at an input edge is processed by processing circuits (hereinafter, referred to as modules) in the order actually connected and is output to the external memory or the like at an output edge. Thus, the order of processing by the plurality of modules is limited to the order connected in the stage of hardware implementation. Attempting to change the order of processing circuits here to an optional order could lead to an increased scale of circuit due to necessity of a complex configuration or substantial degradation in processing performance due to an increase in complex processing.

According to the method of Japanese Patent Application Laid-Open No. 63-247858 or Japanese Patent No. 3907471, if the packets in the ring bus are occupied by some module, transfer efficiency of data may drop. For example, another processing module may not be able to output data to the ring bus, leading to a deadlock.

### SUMMARY OF THE INVENTION

According to an aspect of the present invention, an apparatus in which a plurality of modules are connected in a ring shape via a bus and the modules process data while transferring a packet in a ring in one direction, each processing module includes a processing unit configured to process and output data stored in a packet, a transmitting unit configured to transmit the packet to the module on a downstream side, and a control unit configured to control the transmitting unit so that when the processing unit requires a predetermined length of processing time before one packet is processed and output, the transmitting unit transmits a plurality of packets in the predetermined length.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a schematic configuration of a module connected to a bus.

FIG. 2 illustrates a format of a packet.

FIG. 3 illustrates a schematic configuration of a data processing unit having a ring bus.

FIG. 4 illustrates a schematic configuration of a data processing apparatus.

FIG. 5 illustrates a schematic configuration of the data processing apparatus having two buffers for each module.

FIGS. 6A to 6H illustrate a behavior of the packet passing through each communication unit when a working speed of the communication unit is set to more than double that of a processing unit.

FIG. 7 illustrates activation processing of the data processing unit.

FIG. 8 illustrates the module configuration when a data holding unit is provided outside the module.

FIG. 9 illustrates the module configuration when FIFO is provided between the communication unit and the processing unit.

FIG. 10 illustrates a schematic configuration of the data processing apparatus having the module with the FIFO provided between the communication unit and the processing unit.

### DESCRIPTION OF THE EMBODIMENTS

Various exemplary embodiments, features, and aspects of the invention will be described in detail below with reference to the drawings.

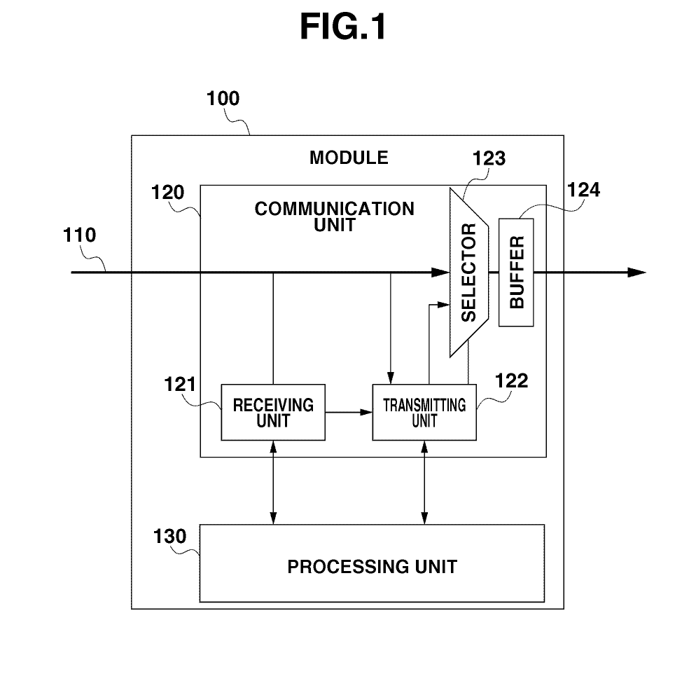

FIG. 1 illustrates a schematic configuration of a processing module (hereinafter, referred to as a module) included in a data processing apparatus according to a first exemplary embodiment of the present invention.

A module 100 is one of modules connected to a ring bus in a ring shape by a bus 110. Here, the ring bus indicates a network (a path through which data passes) in a ring shape formed by a bus and a plurality of nodes (modules) and in the description below, a communication path connecting modules in an annular shape will be simply called a bus, which is a portion of a ring bus.

A communication unit 120 transmits/receives data between modules and transmits/receives data to/from a processing unit 130. The communication unit 120 also has a role to temporarily hold a packet moving from module to module each time when a predetermined number of clocks are input.

A receiving unit 121 identifies and receives, among data packets received from the bus 110, data packets to be processed by the processing unit 130 and extracts data from the packets and transfers the data to the processing unit 130. The processing unit 130 processes the data transferred from the receiving unit 121. A transmitting unit 122 stores the data processed by the processing unit 130 or stall information or the like described below by the communication unit 120 in a packet and further outputs the packet to a selector 123.

The selector 123 selects and outputs a packet input from the bus 110 directly or a packet processed by the transmitting unit 122. The selector 123 is controlled by the transmitting unit 122. A buffer 124 temporarily holds output of the selector 123 only for the unit time. Moreover, by performing control so that each module passes a packet acquired from upstream of the ring bus to downstream, the packet will move around the ring of the ring bus only in one direction.

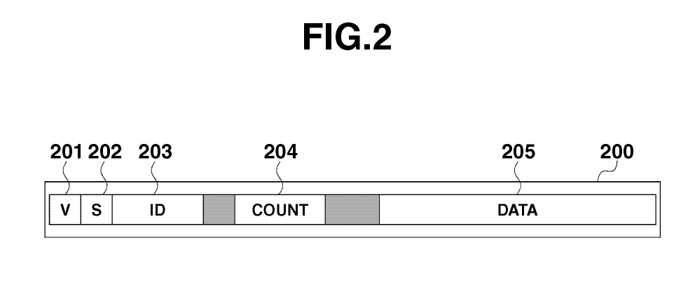

FIG. 2 is a diagram illustrating a data configuration of a packet 200 passing through the ring bus.

A valid flag 201 indicates that a packet has valid data stored therein. A stall flag 202 (stall information) indicates that a packet is in a state (stalled state) in which a packet is stalled without being received by the module to process the packet. An ID 203 is an ID that indicates a transmission source (or a module that has performed processing last) of data, and a count 204 is a count value indicating the order of transmission of data and is used by modules to check the order of data to be processed.

Data 205 stores data to be processed by each module or data processed thereby. Thus, the module 100 has a register to store the ID specific to each module and the ID to identify packets to be processed (hereinafter, referred to as a waiting ID) and a counter to count the value indicating how far a sequence of data is processed (input/output count value).

An operation of the module 100 will be described below. When data processed by the module 100 is output to the bus, the transmitting unit 122 detects the valid flag 201 of an input packet received by the module from the bus to search for an invalid packet (empty packet). If the valid flag 201 of an input packet indicates that the packet is valid, the transmitting unit 122 stores the input packet directly in the buffer 124 and outputs the packet at the next clock.

On the other hand, if the valid flag 201 of an input packet indicates that the packet is invalid and there is data processed by the processing unit 130 and ready for output, the transmitting unit 122 stores the processed data in an empty packet. More specifically, the transmitting unit 122 stores the processed data in an empty packet, sets a value indicating to be valid to the valid flag 201, sets a value indicating to be invalid to the stall flag 202, and adds the module ID (transmission source ID) of the transmitting unit 122 and the value of an output counter (not illustrated) to the packet.

Then, the transmitting unit 122 outputs the packet to the bus at the next clock. At this point, the output counter is incremented and used for identification processing of the packet to be processed next.

When the module 100 receives a packet from the bus 110, the receiving unit 121 monitors the valid flag 201, the transmission source ID 203, and the count value 204 of the input packet. Then, if the receiving unit 121 determines that a packet is input in which the valid flag 201 is valid, the transmission source ID 203 matches the waiting ID set to the register, and the count value 204 matches the input count value, the receiving unit 121 performs capture processing of data.

More specifically, the receiving unit 121 verifies that the processing unit 130 is ready to receive data and then captures data of the input packet into the processing unit 130. After the valid flag 201 being made invalid, the input packet is output to the bus from the next transmitting unit 122 through the buffer 124. At this point, an input counter (not illustrated) is incremented to update the input counter value.

If, in this case, the processing unit 130 in the module is not ready for reception, the receiving unit 121 sets a value indicating to be valid to the stall flag 202 (that is, data capturing is stalled) of the input packet and outputs the input packet to the buffer 124 without changing any other field. The input counter and the output counter are initialized to the same value before starting data transmission for synchronization.

On the other hand, if the receiving unit 121 monitoring the input packet causes packets satisfying one of conditions that the valid flag 201 is invalid, the transmission source ID 203 does not match the waiting ID set to the register, and the count value 204 does not match the input count value to pass to a downstream bus.

By setting the module specific ID and the waiting ID, as described above, a plurality of modules can process data in a desired order with a simple configuration.

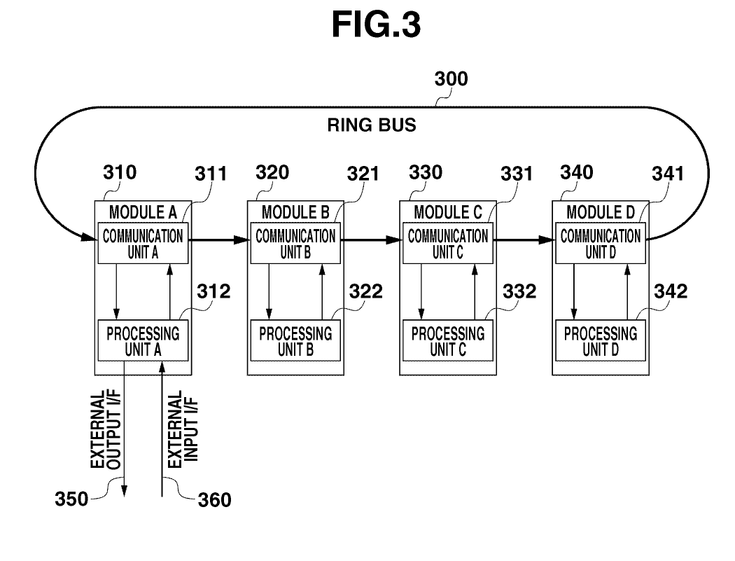

FIG. 3 illustrates a schematic configuration of an image processing unit having a ring bus 300 connecting modules A to D (module 310, module 320, module 330, and module 340) in a row.

The module 310 is a terminal module having a function to have data from outside via external input 360 connected to a data bus outside the image processing unit input thereinto and to output data whose processing is completed to the outside by external output 350. The modules 320, 330, and 340 are processing modules connected to the ring bus 300 and to which fixed processing is assigned.

Each of these modules 310, 320, 330, and 340 has communication units 311, 321, 331, and 341 connected to the ring bus to transmit/receive data, and processing units 312, 322, 332, and 342 to perform individual processing respectively.

These processing units may perform different processing from module to module or the same processing may be performed by some modules a plurality of times. FIG. 3 illustrates an image processing unit having four modules, but the number of modules connected to the ring bus is not limited as long as two or more modules to which fixed processing is assigned are connected.

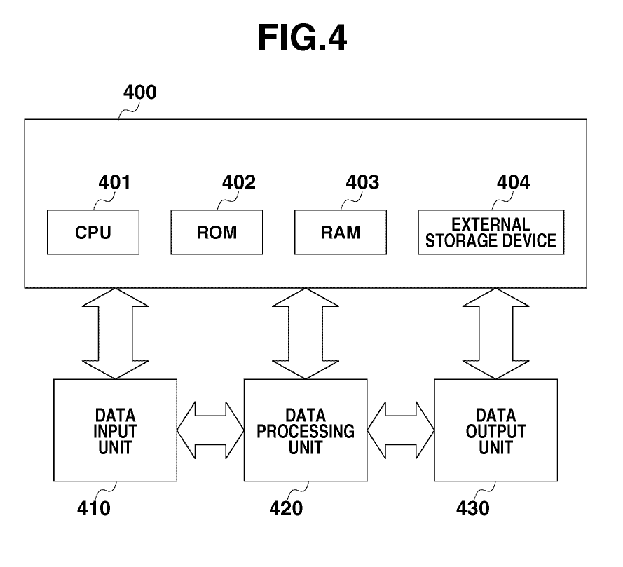

FIG. 4 illustrates a configuration example of a system in which the image processing unit (data processing unit) of the present invention is arranged. A system control unit 400 is a system control unit having a central processing unit (CPU) 401 for arithmetic control, a read-only memory (ROM) 402 that stores fixed data and programs, a random access memory (RAM) 403 used for temporarily storing data and loading programs, and an external storage device 404 that holds external data.

A data input unit 410 captures data to be processed. The data input unit 410 may be, for example, an image reading apparatus including an image scanner and a device such as an analog/digital (A/D) converter, an audio input apparatus including a microphone and a device such as an A/D converter, or a receiving unit that acquires data from an input apparatus.

An image processing unit 420 is a data processing unit in which modules for data processing are connected in a row by the bus illustrated in FIG. 3. Here, the image processing unit 420 is denoted as the data processing unit because it is desirable to apply not only images but also data suitable for a sequence of processing such as pipeline processing to the unit.

A data output unit 430 outputs processed data to the outside. The data output unit 430 may be, for example, an image output apparatus including a printer device that outputs image data after being converted into a print dot pattern or an audio output apparatus that outputs audio data after being converted by an A/D converter. Naturally, the data output unit 430 may simply be a transmitting unit that transmits data to an external apparatus.

Data input into the data input unit 410 may be processed by the CPU 401 after being sent to the system control unit or directly recorded temporarily in the RAM 403 or the external storage device 404. The image processing unit 420 may perform processing by directly receiving input data from the data input unit 410 or perform processing based on instructions and data supply from the system control unit 400.

The output from the data processing unit 420 may be sent to the system control unit 400 again or directly to the data output unit 430.

The image processing unit 420 operates, after individual data processing content being set by processing of the system control unit 400 in advance, to perform the set processing on supplied data.

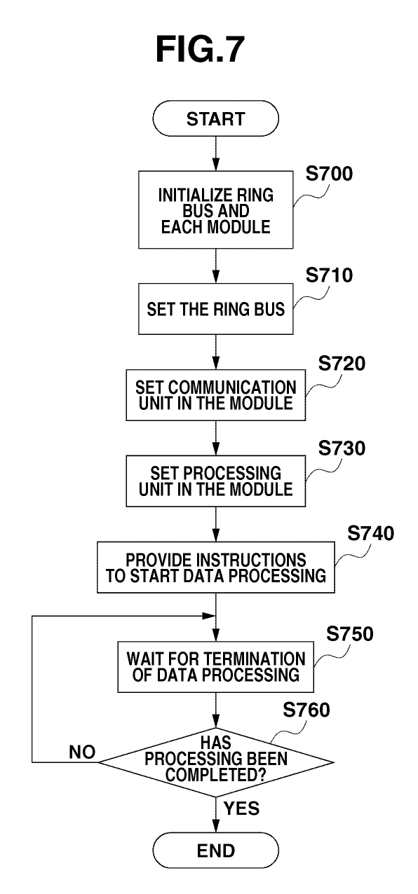

FIG. 7 is a flow chart illustrating a processing procedure for the data processing unit 420 of the system control unit 400.

When control processing is started, in step S700, the system control unit 400 resets a data processing apparatus. Here, the system control unit 400 initializes the input data counter/output data counter (not illustrated) and the register for holding waiting IDs in the communication unit 120 inside each of the modules 100.

Also, the system control unit 400 initializes the working speed of a communication processing unit in the ring bus and the number of buffers that can be used by each module. The system control unit functions as a working speed control unit that controls the working speed, and as a change unit that changes the number of used buffers (number of stages).

In step S710, the system control unit 400 makes settings of the ring bus including the working speed of the communication processing unit in the bus and in step S720, the system control unit 400 makes settings of the waiting ID to identify received data, and the number of stages in the communication unit 120 of each module.

In step S730, the system control unit 400 specifies parameters for the processing unit and in step S740, the system control unit 400 issues instructions to start data processing. Then, in step S750, the system control unit 400 performs processing to monitor for an end notification of the data processing, which is repeated in step S760 until the system control unit 400 determines that a processing end is detected.

In step S760, if the system control unit 400 verifies the end notification of the data processing apparatus (YES in step S760), the processing terminates.

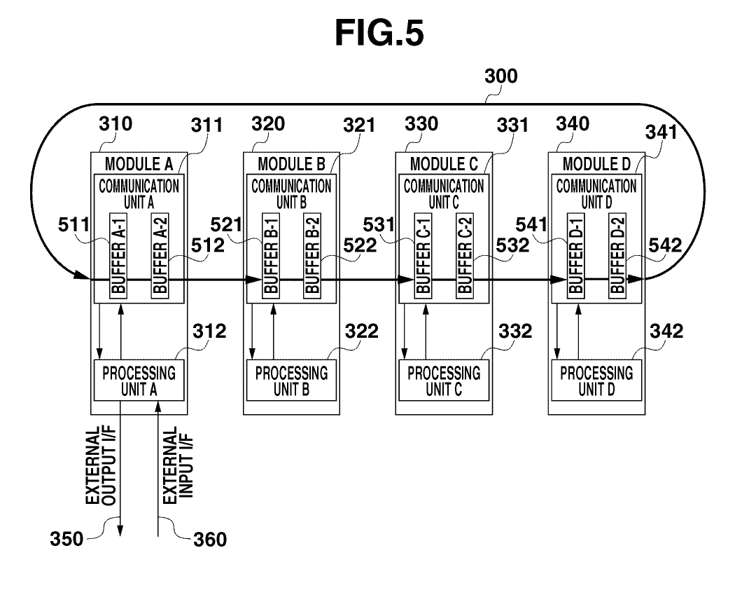

FIG. 5 is a schematic diagram illustrating a configuration of a buffer in the image processing unit of FIG. 3 in detail. Buffers corresponding to the buffer 124 illustrated in FIG. 1 are buffers 512, 522, 532, and 542 and here, buffers 511, 521, 531, and 541 are further added.

Here, normally the buffers 512, 522, 532, and 542 are each configured to hold content of the buffer immediately before at the next clock and to send the content to the next module at the next clock thereafter.

The buffers 512, 522, 532, and 542 are not directly connected to the processing unit 130, the receiving unit 121, the transmitting unit 122, and the selector 123 in the modules. With the buffers 512, 522, 532, and 542 inserted, transmission/reception of data between modules is delayed by one cycle.

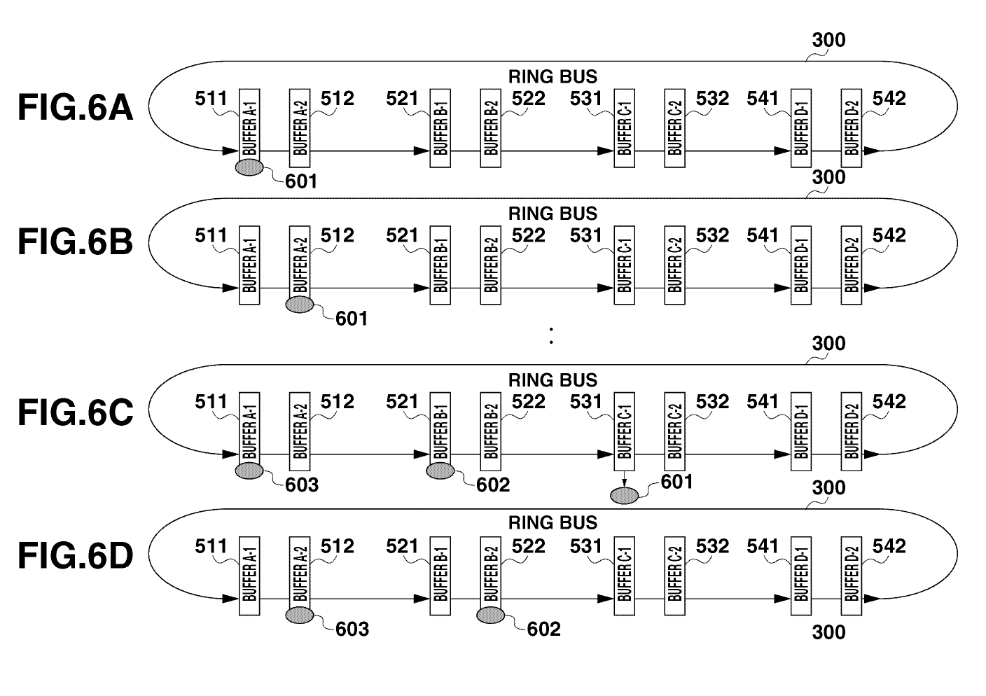

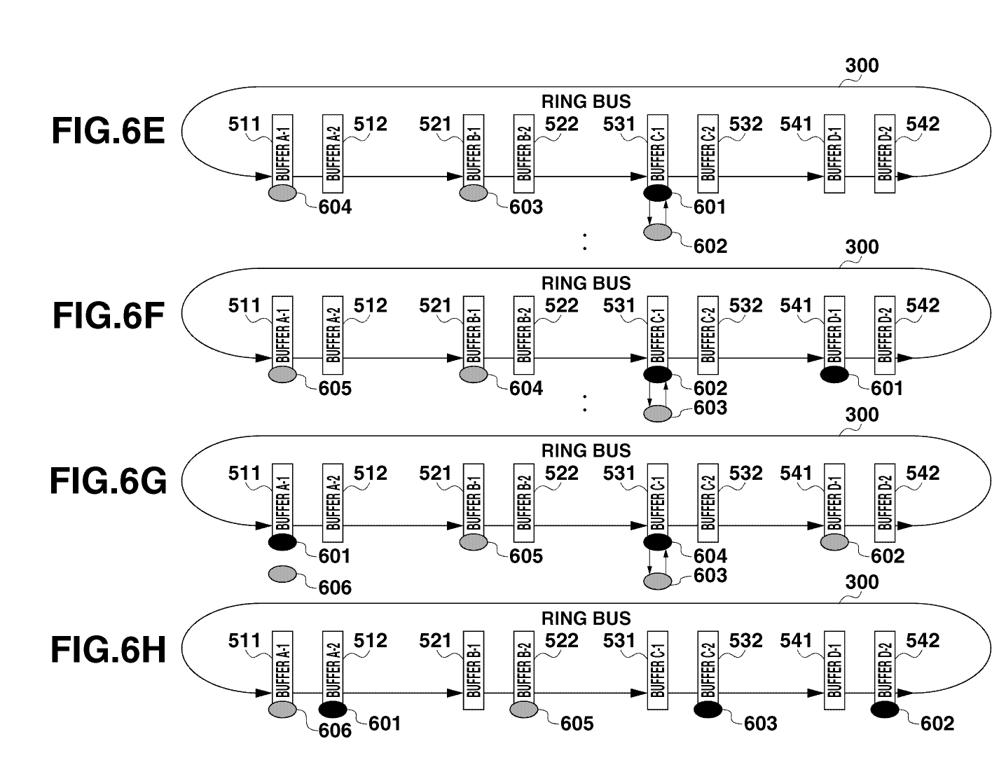

A behavior of a packet moving through the ring bus 300 when the working speed of the communication units A to D is made to operate at the double speed of the processing unit will be described referring to FIGS. 6A to 6H. For simplification of description, it is assumed below that data is packetized for each predetermined amount of data.

FIG. 6A illustrates a state in which first data 601 is input into a ring bus in the 0-th cycle, and held in a buffer A-1 (511). FIG. 6B illustrates a state in which the data 601 input before is moved and held in a buffer A-2 (512). Since the processing unit of the module A is operating at half the cycle of the communication units A to D, data cannot be input in this timing. Similarly, next data 602 is input in the next cycle and further in the next cycle, the data 601 and the data 602 each move to the buffer on the right.

FIG. 6C is a state in the fourth cycle after the start of operation. In this state, no processing units have received data to be processed. Then, the data 601 reaching a buffer C-1 of the module C is directly captured by the processing unit of the module C and does not remain in the buffer C-1.

FIG. 6D illustrates a state in the fifth cycle. At this point, the processing unit C is operating at half the speed of the ring bus and is halfway through processing and thus, even if the throughput is 1, the data input before cannot be output, which leaves the buffer C-1 (531) empty.

FIG. 6E illustrates a state in the sixth cycle. At this point, the processing unit of the module C connected to the buffer C-1 (531) has completed processing of the data 601. Thus, the data 601 is ready for output and at the same time, receives the next data 602 and therefore, while the processed data 601 is stored in the buffer C-1 (531), and the data 602 to be processed next is sent to the processing unit C.

FIG. 6F illustrates a state in the eighth cycle. At this point, the processing unit of the module C has completed processing of the data 602 again and thus outputs the data 602 to the buffer C-1 (531) while next data 603 being received.

FIG. 6G illustrates a state in the tenth cycle. At this point, the processing unit of the module A attempts to input next data 606, but does not capture the data 606 because the data 601 that has moved around the ring bus is present in the buffer A-1.

FIG. 6H illustrates a state in the eleventh cycle. The data 606 that could not be input before can now be input because the buffer A-1 is empty, and when the processing unit of the module A attempts to output the next data in the next cycle, the next data can be output because there is no data that cannot be output and thus stalled.

Thus, according to the present exemplary embodiment, by setting the working speed of the communication unit to the double speed of the processing unit, when data moves normally without hindrance, data stored in every other packet can automatically be made to move around the ring bus.

Accordingly, when competition of data transmission to the bus occurs between the communication units, every other empty packet can be made to be used for data transmission. Thus, by simply setting a relationship between the working speed of the communication unit and that of the processing unit, delay of the data flow can be reduced to a minimum without special control processing.

FIGS. 6A to 6H have been described using the time in a cycle unit for simplification, but the time may not be multiples of the cycle to be the basis of a system such as the system clock, and may be integral multiple of throughput (for example, the time necessary to process one packet) of the processing unit of each module.

This is because, as illustrated in FIGS. 6A to 6H, it is only necessary to generate an empty packet by at least one piece of data being moved before the processing unit outputs input data. Thus, the technique of the present invention is applicable even if the operation throughput of the processing unit does not necessarily process one piece of data in one cycle.

Moreover, to be also applicable when each module does not operate in the same throughput, the technique of the present invention can be configured to be applicable to a group of modules of any throughput by operating the communication unit at an integral multiple of the basic clock.

It is assumed, for example, that there are modules 1 to 3, the processing time of the module 1 can be represented as 3T when the cycle of the basic clock is T, that of the module 2 is 2T, and that of the module 3 is 5T. A clock C representing the frequency can be expressed as C=1/T. Then, by operating the communication unit with a kC (k is an integer equal to 1 or greater) clock, the modules 1 to 3 will not exclusively hold a packet continuously moving in a period corresponding to one processing time.

If, in the above case, the reference speed of the ring bus (the working speed of the communication unit) is set to 2T, the phase is shifted by T from the module 1 whose processing time is 3T, which makes processing less efficient. Therefore, when modules of a plurality of processing speeds are mixed, the working speed of the communication units may be set so that, based on the greatest common divisor of processing times of a plurality of modules, one packet is output to a length of the greatest common divisor or less.

Naturally, the greatest common divisor is used when based on the cycle T and the least common multiple when based on the clock frequency, and these are synonymous.

If focused on one processing module having a predetermined processing time until one packet is processed and output, the above control is synonymous with performing control so that the transmitting unit transmits at least two packets in the predetermined processing time.

Moreover, the number of intervals between data can be increased by causing the communication unit to operate at the speed according to the ratio of the number of inserted buffers or increasing the amount of data movement in the ring bus while the processing unit processes input data. Here, intervals between data also correspond to the number of empty packets between two valid packets.

In addition, when a plurality of data processing streams are moved through the same ring bus, it is effective to increase the working speed of the ring bus according to the number of data processing streams moved at the same time. For example, when two data processing streams are moved at the same time (for example, two systems of pipeline processing are moved to the data processing unit 420), double data compared with a casein which one data stream is moved may move through the ring bus.

In such a case, to obtain the same behavior as when one data processing stream is moved, it is effective to double the working speed of the ring bus after doubling the number of buffers in the ring bus. Moreover, to realize a plurality of data processing streams in the same ring bus, each processing unit needs to have a register to identify as many waiting IDs as the number of data streams, and a data packet needs to store information to identify the type of stream.

Reasons why a packet has only the ID of a transmission source include that the amount of information of the packet can be reduced by deleting information about the transmission destination and it is more effective to use the ID of a transmission source in terms of making use of stalled packets. Reasons why it is more effective to use the ID of the transmission source include the fact that modules more favorable for detecting a stalled packet are those modules having the ID of a transmission source added thereto.

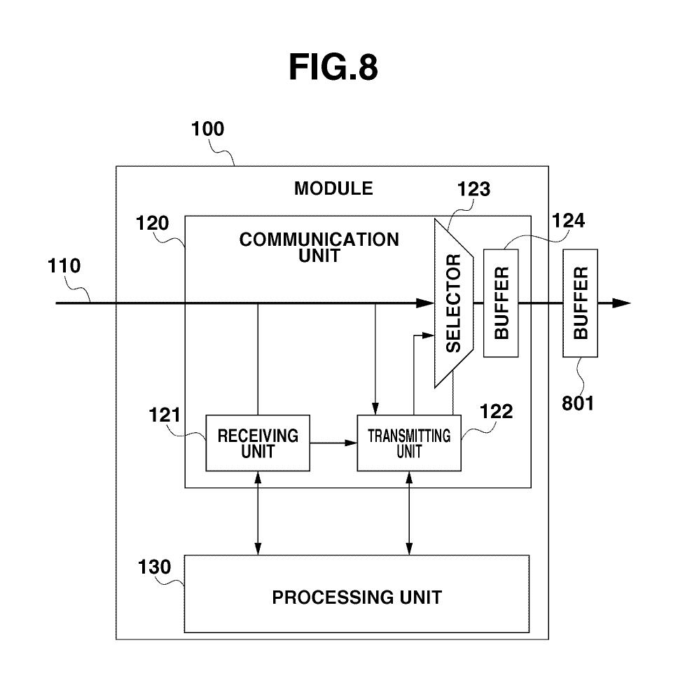

Moreover, as illustrated in FIG. 8, a buffer 801 may be provided between modules. Accordingly, it becomes easier to increase the number of buffers capable of holding data packets, and also degradation in efficiency of the ring bus can be minimized.

Naturally, the buffer 801 may be configured as a buffer in two stages or more, or as a buffer whose number of stages is variable. Also in that case, processing efficiency of the ring bus can be improved by increasing the working speed of the communication unit 120 in the ring bus according to the number of stages for the processing unit 130.

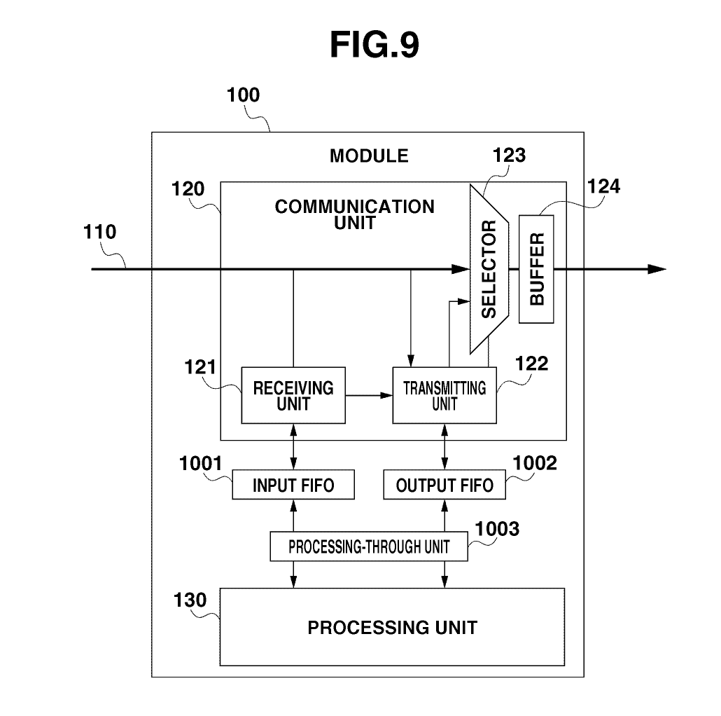

FIG. 9 is a block diagram illustrating a schematic configuration of a module according to a second exemplary embodiment of the present invention. In the description of the second exemplary embodiment below, the same reference numerals are attached to components or processes having the same function as those in the first exemplary embodiment, and a description of components or processes that remain configurationally or functionally unchanged will not be described.

Further, an input FIFO 1001 temporarily holds data received by the communication unit before the data being delivered to the processing unit. Data of several stages of FIFO can temporarily be held by the input FIFO 1001 even during processing of the processing unit 130, so that the frequency of a packet with a set stall flag moving around the ring bus can be reduced.

An output FIFO 1002 is an output FIFO used when processed data is delivered to the communication unit by the processing unit. Even when data cannot be output to the communication unit due to the lack of empty packet in the ring bus, the processing unit can be freed by output data of the processing unit being held by the output FIFO, enabling shift to processing of the next data.

Further, a processing-through unit 1003 directly delivers an output from the input FIFO 1001 to the output FIFO 1002. By effectively setting the processing-through unit 1003, data can be moved directly from the input FIFO 1001 to the output FIFO 1002 without going through the processing unit 130 and therefore, the two FIFOs can be used as virtual buffers connected to the ring bus.

For example, depending on processing that the data processing unit 420 is caused to perform, a module not used for processing may be generated.

In such a case, in step S730, which is setting processing of the system control unit 400 in FIG. 7, the processing-through unit 1003 may be enabled for modules to which no waiting ID is set when the waiting ID is set for each data processing unit. When the processing-through unit 1003 is enabled, the receiving unit 121 may be set to receive all packets.

If there is a difference in performance between modules, or modules are specialized for specific processing (such as filters for image processing), the possibility of a module not used for processing being generated increases, so that opportunities of an effect being achieved by the present exemplary embodiment will increase.

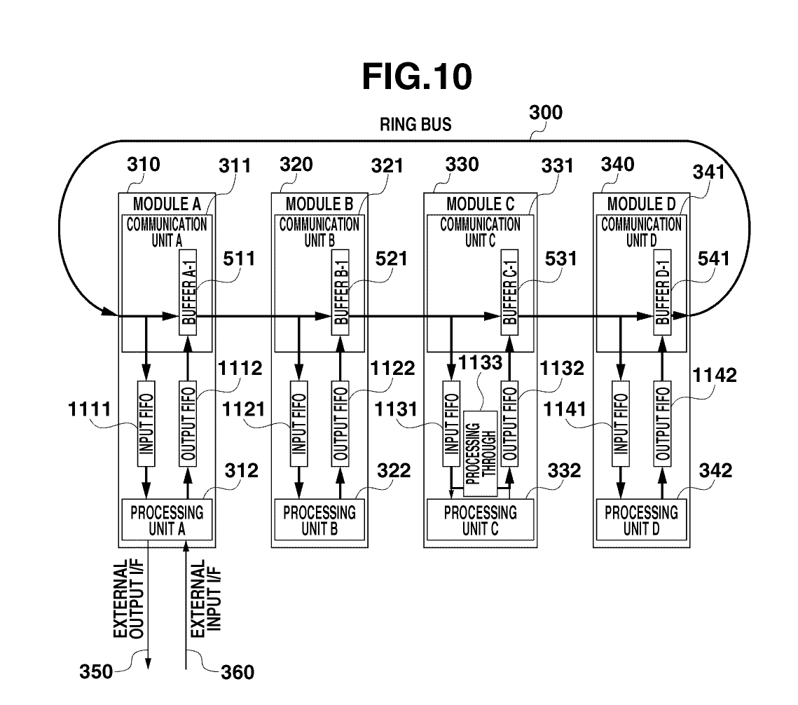

On the other hand, even if the processing-through unit 1003 is enabled, the system control unit 400 may set a specific waiting ID for the receiving unit 121 in step S730. FIG. 10 is an example in which a ring bus is configured by using the module configuration illustrated in FIG. 9.

Input FIFOs 1111, 1121, 1131, and 1141 temporarily hold data received by the communication unit in the ring bus in each module while being processed by the processing unit. Output FIFOs 1112, 1122, 1132, and 1142 temporarily hold processed data processed by the processing unit in the ring bus when the data is output to the communication unit.

A processing-through unit 1133 connects an input FIFO 1131 and an output FIFO 1132 without going through the processing unit. The path going through the input FIFO 1131, the processing-through unit 1133, and the output FIFO 1132 can be set by specifying a specific ID as a waiting ID in the communication unit 331 in advance and setting the processing-through unit 1133 to through. Accordingly, the processing-through unit 1133 can be inserted between desired processing in a sequence of data processing (such as pipe line processing) as a buffer.

Thus, an unused processing unit, as a data holding unit on the ring bus, can be applied as a buffer by pinpointing the location between desired processing, so that throughput of the ring bus can be improved with the minimum circuit configuration.

According to the second exemplary embodiment, as described above, a virtual buffer acting in a specific sequence of processing can be prepared. By handling such a module not used for specific processing as a buffer, buffers working effectively in the ring bus can be arranged without increasing the circuit scale.

Moreover, by inserting a buffer, it becomes possible to prevent data from being stalled, and minimize lowering of processing speed when packets with a stall flag increase.

When data passes through the processing unit, the clock needs to be supplied also to the processing unit and thus, if the processing unit is skipped, the processing unit can be turned off, reducing power consumption.

In the second exemplary embodiment, however, buffers are not arranged equally between the processing units like the technique illustrated in the first exemplary embodiment. In such a case, the ring bus may be caused to operate at a speed determined from a total number K of buffers operating effectively in the ring bus and a total number L of the processing units whose data processing is enabled, instead of the ratio of buffers in each module.

In this case, the ratio determined by K/L offers guidance of how many times the working speed of the processing unit the ring bus is caused to operate.

For example, when buffers are arranged on a specific data processing stream so that K/L becomes 2, the number of steps needed to move around caused by an increase of buffers in the ring can ideally be canceled out by setting the working speed of the ring bus to double the working speed of the processing unit. Then, the time needed for data to move around the ring bus does not change with every other packet being generated as an empty packet.

A module not used for processing may be used as a buffer only when stalled packets increase or the amount of data held by each communication unit of the ring bus exceeds a threshold level.

In the description of a third exemplary embodiment below, the same reference numerals are attached to components or processes having the same function as those in the first or the second exemplary embodiment and a description of components or processes that remain configurationally or functionally unchanged will not be described.

In the example discussed in the second exemplary embodiment, any number of buffers can be inserted under the constraint of integral multiples of the number of stages of FIFO for a specific data processing stream in the ring bus. In the third exemplary embodiment, the total number K of buffers to be inserted is determined based on a working speed R determined from a number S of data processing streams input at the same time and the number L of processing units operating effectively.

If, for example, there are two data processing streams input at the same time, two pieces of data can be transferred while the processing unit performs a unit of data processing by doubling the working speed of the ring bus.

If, in such a case, the capacity of buffers connected to the ring bus is not increased, the amount of data moving in the ring bus simply doubles in the end, increasing the possibility of a deadlock of the ring bus after some kind of data being stalled.

Thus, it is necessary to increase the data capacity that can be held in the ring bus according to an increase in the working speed of the ring bus. Then, if the working speed of the ring bus should be doubled, it is necessary to more than double the number of buffers in the ring bus.

Realistically, it is rare that the operating frequency can be made any integral multiple and the selection of a frequency of 2 to the nth power is frequently forced to make. Thus, actually using the frequency, which is obtained by being multiplied by 2 to the nth power that exceeds and is closest to the number of data processing streams input at the same time, is more realistic.

Thus, for example, if 2 to the nth power that exceeds and is closest to the number of data processing streams input at the same time is S′, the total number K of stages of buffers effectively operating in the ring bus may be determined by K=L×S′ based on the total number L of the processing units operating effectively.

Here, the working speed of the ring bus may be set K/L times or (M+N) times the operating reference signal (clock). If the processing unit operates slowly and needs T clocks to process one piece of data, the working speed of the ring bus may be K/L times or (M+N) times the value obtained by dividing the cycle of the operating reference signal by T.

If, for example, performance of the processing unit is the throughput of one piece of data in 10 cycles and K/L=2 when the operation reference signal of 100 MHz is provided to the processing unit, the ring bus may be operated at (100 MHz/10 cycles)×2=20 MHz. Thus, the operating frequency of the ring bus may be slower than the operation reference signal.

In practice, however, modules connected to the ring bus may not all have the processing units operating at the same processing speed. In such a case, the number of cycles necessary for the slowest processing unit to process one piece of data is made to be a reference and the ring bus may be operated at the operating frequency K/L times or (M+N) times thereof.

In each exemplary embodiment described above, the processing unit 312 is in charge of both output of data to the outside and input of data from outside, but a processing unit for input and a processing unit for output may be provided separately or a plurality of processing units for input or output may be provided. Further, data acquired from outside may be input unchanged in the packet format to be handled in the ring bus. Further, the processing unit may be configured to be capable of interpreting a packet to process the packet as it is.

Processing of each exemplary embodiment described above may be realized through collaboration of a plurality of pieces of hardware and software. In such a case, processing can be realized by executing software (program) acquired via a network or various storage media in a processing apparatus (a CPU or processor) such as a computer.

The present invention may also be realized by supplying a computer-readable storage medium storing a program that causes a computer to realize functions of the exemplary embodiments described above to a system or an apparatus.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., non-transitory computer-readable storage medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-130852 filed May 29, 2009, which is hereby incorporated by reference herein in its entirety.

What is claimed is:

1. An apparatus in which a plurality of modules are connected in a ring shape via a bus and the modules process data while transferring a packet in a ring in one direction, each of the module comprising:
a processing unit configured to process and output data stored in the packet;
a transmitting unit configured to transmit the packet to the module on a downstream side; and
a control unit configured to control the transmitting unit so that when the processing unit requires a predetermined length of processing time before one packet is processed and output, the transmitting unit transmits a plurality of packets in the predetermined length.

2. The apparatus according to claim 1, wherein the control unit controls the transmitting unit so that one packet can be transmitted in the length of time or less of a greatest common divisor of processing times of the plurality of modules for each the predetermined length of the plurality of the modules.

3. The apparatus according to claim 1, the module further comprising a setting unit configured to set an ID of the packet to be processed to the processing module according to content of pipeline processing performed by the plurality of processing units.

4. The apparatus according to claim 1, the module further comprising:
a register configured to store an ID of the packet to be processed; and
a receiving unit configured to transfer, to the processing unit, the data stored in the packet whose ID and the ID of the packet to be processed match.

5. The apparatus according to claim 4, wherein the receiving unit allows the packet whose ID and the ID of the packet to be processed do not match to pass to the bus directly.

6. The apparatus according to claim 1, further comprising:
an input unit configured to input the data into the bus in the ring shape.

7. The apparatus according to claim 1, further comprising:
an output unit configured to output the packet to an external unit according to an ID of the input packet.

8. The apparatus according to claim 1, wherein the transmitting unit further includes a register that stores an ID specific to the transmitting unit and transmits the packet storing the data processed and the specific ID to the bus.

9. The apparatus according to claim 1, wherein if an ID of the packet and the ID of the packet to be processed match and the processing unit is not ready to receive the data, the transmitting unit transfers the packet after stall information is added thereto.

10. An apparatus in which a plurality of modules are connected to a ring bus and the plurality of modules performs data processing in a preset order, each of the modules comprising:
a holding unit configured to hold received data for a predetermined time; and
a transmitting unit configured to transmit the held data to another module.

11. An apparatus in which a plurality of modules are connected to a ring bus and the plurality of modules performs data processing in a preset order, each of the modules comprising:
a communication unit configured to transmit/receive data in a ring bus and a processing unit configured to perform processing of received data;
an input FIFO that temporarily holds the received data, an output FIFO that temporarily holds output data processed by the processing unit;
a processing-through unit configured to transmit the data from the input FIFO to the output FIFO without going through the processing unit; and
a switching unit configured to switch an operation of the processing-through unit between the communication unit and the processing unit.

12. The apparatus according to claim 11, wherein if a total number of data holding units operating effectively in the ring bus is K, the total number of the processing units effectively operating is L, and the number of data processing streams input into the ring bus at the same time is S,
the switching unit switches the processing-through unit so that K≧L×S is satisfied.

13. The apparatus according to claim 1, wherein the packet includes information indicating whether the stored data is valid, information indicating whether the packet is in a stalled state, and information indicating an ID of the module that output last and an order of input into the bus.

14. The apparatus according to claim 1, the module further comprising:
a data holding unit connected to the bus; and
a change unit configured to change a number of stages of the data holding unit.

15. The apparatus according to claim 1, the module further comprising
a speed control unit configured to control a speed of at least one of the transmitting unit and the processing unit.

16. The apparatus according to claim 15, wherein if a number of stages effectively operating among data holding units each inserted between individual modules connected to the bus is N, and the number of stages effectively operating among data holding units connected to the bus is M, the speed control unit performs control so that the speed of the transmitting unit is an integral multiple of (N+M) of the speed of the processing unit.

17. The apparatus according to claim 16, wherein if the total number of the data holding units connected to the bus and operating effectively is K, and the total number of the processing units operating effectively is L, the speed control unit performs control so that the speed of the transmitting unit is (K/L) times the speed of the processing unit.

18. A method for an apparatus in which a plurality of modules are connected in a ring shape via a bus and the modules process data while transferring a packet in a ring in one direction, comprising:
processing the data stored in the packet;
transmitting the packet to a downstream side; and
performing control so that during one packet being processed and output, a plurality of packets is transmitted.

19. A non-transitory computer-readable storage medium storing a program that controls an apparatus in which a plurality of modules are connected in a ring shape via a bus and the modules process data while transferring a packet in a ring in one direction, the program causing a computer to function as:
a processing unit configured to process and output the data stored in the packet;
a transmitting unit configured to transmit the packet to the module on a downstream side; and
a control unit configured to control the transmitting unit so that while the processing unit processes and outputs one packet, the transmitting unit transmits a plurality of packets.
